(19) United States
(12) Patent Application Publication
(10) Pub. No.: US 2009/0185746 A1
(43) Pub. Date: Jul. 23, 2009

(54) IMAGE RECOGNITION

(75) Inventors: Ajmal Saeed Mian, Yokine (AU); Mohammed Bennamoun, Greenwood (AU); Robyn Owens, Nedlands (AU)

Correspondence Address: FOX ROTHSCHILD LLP, 2000 MARKET STREET, 10th Floor, PHILADELPHIA, PA, 19103, US

(73) Assignee: The University of Western Australia, Nedlands (AU)

(21) Appl. No.: 12/017,643

(22) Filed: Jan. 22, 2008

(51) Int. Cl. G06K 9/62

(52) U.S. Cl. 382/209

(57) ABSTRACT

An image recognition method and system (10) comprises receiving at an input (12) a first image set to be recognized, wherein the image set comprises a 3-D image comprising 3-D cloud-points of an observed surface and a registered 2-D image comprising textured pixels. A gallery of image sets is provided in a storage (18) for comparison. A rejection classifier (32) performs a rejection comparison for rejecting image sets in the gallery that do not match the first image set with a high likelihood. A matching classifier (36) performs a matching comparison for identifying an image set of the non-rejected gallery image sets which matches the first image set with a high likelihood.

### FIELD OF THE INVENTION

The present invention relates to image recognition, and in particular, although not exclusively, to face recognition.

### BACKGROUND OF THE INVENTION

Automatic image recognition is a valuable technology that depends on very high accuracy. This is particularly so as the number of images recognized rises. Even relatively high recognition accuracy of, say, 90% accuracy, when used over a thousand recognitions still produces on average 100 inaccurate results. Therefore, even small gains in recognition accuracy can produce significant outcomes. Automatic face recognition in particular, poses a challenging problem because of ethnic diversity of faces and variations caused by expressions, gender, pose, occlusion, illumination and makeup.

There are essentially two types of face recognition used currently. The first is 2-D face recognition. 2-D face recognition has the advantage of widespread availability of cameras capable of capturing 2-D images. The second type of face recognition is 3-D face recognition. This involves using a camera, which is able to produce a set of data that reflects the surface of the face in three-dimensional space. Both of these types of face recognition produce relatively high accuracy in one-off recognition, but their accuracy still falls short of the levels required for mass recognitions.

### BRIEF SUMMARY OF THE INVENTION

According to the present invention, there is provided an image recognition method comprising:

receiving a first image set to be recognized, wherein the image set comprises a 3-D image comprising 3-D cloud-points of an observed surface and a registered 2-D image comprising textured pixels;

providing a gallery of image sets for comparison;

performing a rejection comparison for rejecting image sets in the gallery that do not match the first image set with a high likelihood; and

performing a matching comparison for identifying an image set of the non-rejected gallery image sets which matches the first image set with a high likelihood.

In an embodiment, the rejection comparison comprises a holistic comparison between the first image set and one or more of each gallery image set.

In an embodiment, the rejection comparison comprises a local feature comparison between the first image set and one or more of each gallery image set.

In an embodiment, the rejection comparison comprises comparing 2-D features of the 2-D image of the first image set with each 2-D image of the gallery image sets.

In an embodiment, the rejection comparison comprises comparing 3-D features of the 3-D image of the first image set with each 3-D image of the gallery image sets.

In an embodiment, the method comprises normalizing the first image set.

In an embodiment, the method comprises normalizing each gallery image set.

In an embodiment, the method comprises cropping of a part of the 2-D and 3-D images that are not of interest.

In an embodiment, the images each comprise a face and the method comprises performing face detection on each image set prior to the rejection comparison.

In an embodiment, the face detection comprises detecting the location of the nose tip in each 3-D image and cropping a part of the 3-D image which is not inside of a radius of the detected nose tip. Typically each 2-D imaged is also cropped by cropping parts of each 2-D imaged registered to the cropped part of the registered 3-D image.

In an embodiment, the nose tip is detected by detecting the location of the nose ridge in each 3-D image and determining the highest point along the nose ridge, wherein the nose ridge is defined as a substantially vertical line of local peaks of horizontal 3-D image slices.

In an embodiment, each gallery image set undergoes the same type of cropping as the first image. In an embodiment each gallery image is cropped to remove the part of the image which is not inside a radius of a detected nose tip.

In an embodiment, the first image set is orientation corrected. In an embodiment the first image set is pose corrected.

In an embodiment, each gallery image set is orientation corrected. In an embodiment each gallery image set is pose corrected.

In an embodiment, one of the 3-D features compared is a spherical representation of each 3-D image. In an embodiment each spherical representation is formed by quantizing the distance of each point in the point-cloud to a common keypoint in the 3-D image into spherical bins and then forming an image vector from the spherical bins. In an embodiment the comparison of spherical representations comprises determining a similarity measure between the first image set and each gallery image set by computing the distance between the spherical representation vector of the first image set and the spherical representation vector of each gallery image set. In an embodiment each gallery image with a similarity measure below a threshold is rejected.

In an embodiment, the rejection comparison comprises transforming the first 3-D image into a spherical face representation (SFR) for matching with each gallery 3-D image.

In an embodiment, each gallery 3-D image is transformed into a SFR for matching with the first 3-D image.

In an embodiment, the SFR comparison produces a similarity score. In an embodiment each gallery image set with a similarity score below a threshold is rejected.

In an embodiment, the rejection comparison comprises generating appearance based local features from the first 2-D image for matching with each gallery 2-D image. In an embodiment, an appearance based local feature is a 2-D local feature calculated at a keypoint location.

In an embodiment, each gallery 2-D image has a SIFT generated for matching with the first 2-D image.

In an embodiment, the appearance based local feature comparison produces a similarity score, wherein the gallery image set is rejected if the similarity score is below a threshold.

In an embodiment, the rejection comparison comprises transforming the first 3-D image into a SFR and the first 2-D image into an appearance based local feature for matching with each gallery image set, wherein the SFR comparison produces a SFR similarity score and the appearance based local feature comparison produces a appearance based local features similarity score, wherein the SFR similarity score is combined with the appearance based local features similarity score, such the gallery image set is rejected if the combined similarity score is below a threshold.

In an embodiment, the rejection comparison comprises segmenting the gallery image sets.

In an embodiment, the rejection comparison comprises segmenting the first image set.

In an embodiment, rejection comparison comprises identifying common keypoints in the gallery images and cropping from the images an area which is not surrounding each keypoint by a specified distance over the 3-D surface in the 3-D image.

In an embodiment, a 3-D local feature is extracted from its neighbourhood, wherein the principal directions of the local surface are used to calculate the local feature in the form of a 3-D feature vector.

In an embodiment, a specified number of 3-D feature vectors are calculated.

In an embodiment, each 3-D feature vector is compressed, preferably by projection into a subspace defined by the eigenvectors of their largest eigenvalues using Principal Component Analysis (PCA).

In an embodiment, the 3-D vectors of each gallery image set and a similar vector of the first image set are used to produce a similarity score. In an embodiment the similarity score is used to reject gallery images which do not meet a threshold. In an embodiment, the similarity vector of the first image set is calculated the same way as the vectors of each gallery image set.

In an embodiment, the compressed vectors are then normalized by dividing them by their eigenvalues.

In an embodiment, the normalized compressed 3-D features are indexed using a hash table.

In an embodiment, the 3-D image of the first image set is processed to produce normalized compressed 3-D features using the above method. The normalized compressed 3-D features of the 3-D image of the first image set is used to cast votes in favour of each feature of each image set in the gallery, wherein the gallery image sets which receive more votes are considered for further comparison.

In an embodiment, those gallery image sets with more votes are matched to determine an error value representing misalignment of the respective first image set vector and each of the remaining gallery vectors.

In an embodiment, the gallery feature vectors are sorted according to the error value.

In an embodiment, only features that have the lowest error value from each gallery image set are retained.

In an embodiment, the number of feature matches for each gallery image set is determined and used as a first similarity measure.

In an embodiment, the mean of the error value between the matching pairs of features for each gallery image set is determined and used as a second similarity measure.

In an embodiment, a third similarity measure is determined from the spatial difference between the matching features of the first image set and the corresponding matching features of each gallery image set.

In an embodiment, the matching features on the first image set are used to form a 3-D graph which is then used to construct another graph from the corresponding keypoints of the gallery face and the third similarity measure is determined from a similarity between the two graphs.

In an embodiment, the mean Euclidean distance between the keypoints of the two graphs is determined and used as a fourth similarity measure.

In an embodiment, the four similarity measures a fused.

In an embodiment, one or more of the first, second, third, fourth and fused similarity measures are used to reject gallery image sets not sufficiently similar to the first image set.

In an embodiment, rejection comparison comprises identifying common local features in the gallery 2-D images by cropping the 2-D image according to the cropping of the registered 3-D image.

In an embodiment, a 2-D local feature is extracted from its neighbourhood, wherein the principal directions of the local surface are used to calculate the local feature in the form of a 2-D feature vector.

In an embodiment, a specified number of 2-D local vectors are calculated.

In an embodiment, each 2-D feature vector is compressed, preferably by projection into a subspace defined by the eigenvectors of their largest eigenvalues using PCA.

In an embodiment, one or more similarity measures are determined form the 2-D local features using the same approach described above for 3-D feature comparison.

In an embodiment, the 2-D similarity measures are fused with the 3-D similarity measures.

In an embodiment, gallery image sets with insufficient similarity according to the 2-D, 3-D or fused similarity measures are rejected.

In an embodiment, the method further comprises performing image segmentation of the first image prior to performing the matching comparison, and the matching comparison is performed with the segmented first image set.

In an embodiment, the non-rejected gallery image sets are segmented prior to performing the matching comparison, and the matching comparison is performed on the segmented non-rejected gallery image sets.

In an embodiment, the image segmentation comprises removing readily variable features of the subject of each image. In an embodiment readily variable features are rapidly changeable.

In an embodiment, the image segmentation comprises cropping the 2-D and 3-D images to remove parts that are not in a nose region and/or an eyes and forehead region of a face.

In an embodiment, the image segmentation comprises comparing the 3-D images in the gallery to each other, where all of the images sets of the gallery form members of a domain representing subject matter appearing in the gallery image sets, to identify a vector of keypoints, where the keypoints have similar similarity scores. In an embodiment, one or more localized volumes comprising the keypoints are retained and the remainder are excluded.

In an embodiment, the matching comparison comprises comparing the 3-D image of the first image set with each 3-D image of the non-rejected gallery image sets.

In an embodiment, the matching comparison is performed using a variant of the iterative closest point (ICP) algorithm.

In an embodiment, the ICP establishes correspondences between the closest points of the two sets of the 3-D point-cloud and minimizes the distance error between them by applying rigid transformation to one of the sets. In an embodiment this process is repeated iteratively until the distance error reaches a minimum saturation value.

In an embodiment, when ICP is performed on different segments, then the results are fused.

In an embodiment, the matching comparison comprises registering each local feature of the first 3-D image with each remaining gallery 3-D image and calculating an error between the normal direction to each local feature of each first 3-D first image—gallery 3-D image pair. In an embodiment the errors of each 3-D first image—gallery image pair are fused. In an embodiment the 3-D first image—gallery image pair with the highest similarity are regarded as a match.

In an embodiment, the gallery image set with the highest similarity is selected as the matching identification of the first image set. In an embodiment, the matching identity if only selected if its similarity is above a threshold. In the event that an identity is not selected then the gallery is regarded as not having the identity of the first image set.

In an embodiment, in the event that only one non-rejected image set remains, the matching comparison identifies the remaining gallery image set as a match to the first image set.

According to the present invention, there is provided a image recognition system comprising:

an input for receiving a first image set to be recognized, wherein the image set comprises a 3-D image comprising 3-D cloud-points of an observed surface and a registered 2-D image comprising textured pixels;

a storage for storing a gallery of image sets for comparison;

a rejection classifier for performing a rejection comparison for rejecting image sets in the gallery that do not match the first image set with a high likelihood; and

a matching classifier for performing a matching comparison for identifying an image set of the non-rejected gallery images which matches the segmented first image with a high likelihood.

According to the present invention, there is provided an image recognition system comprising:

an input for receiving a first image set to be recognized, wherein the image set comprises a 3-D image comprising 3-D cloud-points of an observed surface and a registered 2-D image comprising textured pixels;

a storage for storing a gallery of image sets for comparison;

a processor configures to: perform a rejection comparison for rejecting image sets in the gallery that do not match the first image set with a high likelihood; and perform a matching comparison for identifying an image set of the non-rejected gallery images which matches the segmented first image with a high likelihood.

According to the present invention, there is provided a computer program embodied in a computer readable storage medium comprising instructions for controlling a processor to:

receive a first image set to be recognized, wherein the image set comprises a 3-D image comprising 3-D cloud-points of an observed surface and a registered 2-D image comprising textured pixels;

access a storage of a gallery of image sets for comparison;

perform a rejection comparison for rejecting image sets in the gallery that do not match the first image set with a high likelihood; and

perform a matching comparison for identifying an image set of the non-rejected gallery images which matches the segmented first image with a high likelihood.

### BRIEF DESCRIPTION OF THE DRAWINGS

In order to provide a better understanding of the present invention, example embodiments will now be described in greater detail, with reference to the company figures, in which:

FIG. 1 is a block diagram of a recognition device according to an embodiment of the present invention;

FIG. 2 is a block diagram of components of the recognition device of FIG. 1, according to an embodiment of the present invention;

FIG. 3 is a flow chart of a method of normalizing an image set;

FIG. 4A is a graph through an x-z plane coinciding with a horizontal slice of a 3-D image schematically showing detection of a nose tip, according to an embodiment of the of a method of FIG. 3;

FIG. 4B is a three-dimensional image showing a cropping process;

FIG. 5 is a schematic diagram of a rejection classifier, according to an embodiment of the device of FIG. 2;

FIG. 6 is a schematic flowchart of a face recognition process according to an embodiment of the present invention;

FIG. 7A is a graph through an x-z plane coinciding with a horizontal slice of a 3-D image schematically showing detection of points of inflection;

FIG. 7B is a graph through a y-z plane coinciding with a vertical slice of a 3-D image schematic showing detection of points of inflection; and

FIG. 8 is a flowchart of a method of face recognition according to an embodiment of the present invention.

### DETAILED DESCRIPTION OF EMBODIMENTS OF THE INVENTION

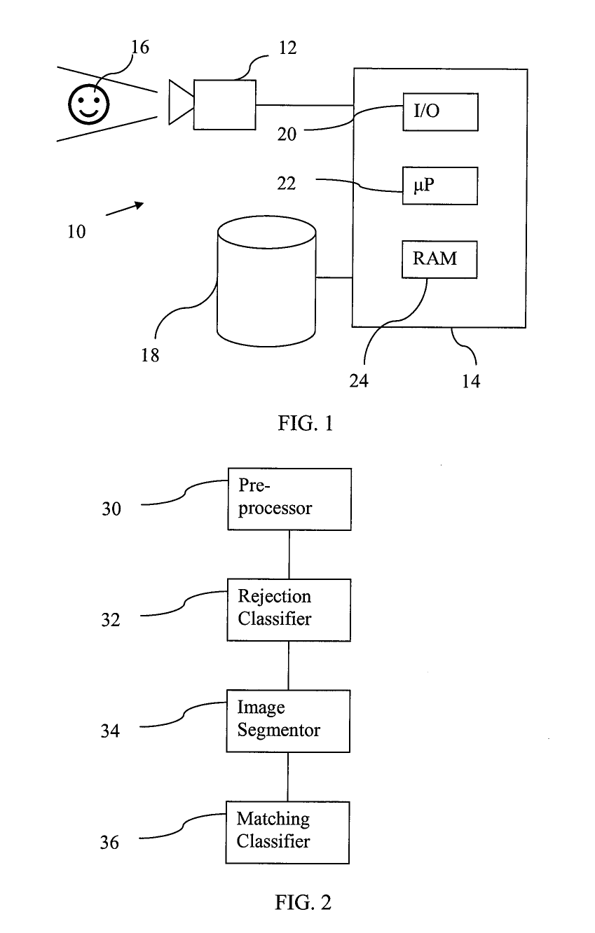

Referring to FIG. 1, there is shown an image recognition system 10, which comprises a camera 12 and a recognition device 14. The recognition device 14 is typically a computer having a processor 22 arranged to operate under the control of instructions of a computer program to perform recognition of an image set captured by the camera 12. The computer program is typically loaded from a storage media, such as a CD, hard disk, or flash memory, into RAM of the computer for execution.

The camera 12 is capable of capturing an image set comprising a 2-D image and a 3-D image, which are registered with each other. That is, they are taken from the same or substantially the same point of view to capture an image of the same subject 16 and each point in the 3-D image can be mapped to one or more corresponding points in the 2-D image or vice versa. The resolution need not be the same. The 3-D image is formed from, for example, a laser scanner of the camera 12 which finds the range (from the camera 12) of each point of an observed surface of the subject 16. The 3-D image comprises 3-D cloud-points of the subject surface, that is a cloud of range (from the camera) values (that is, z-axis values) for every point in the x-y plane. The 2-D image comprises a textured pixel for every point in the x-y plane of a captured image of the subject 16. Texture can be colour or greyscale. It is noted that the 3-D image can be obtained other than by a laser scanner, for example multiple 2-D images of the same subject from known different points of view could be used to calculate the 3-D image.

In order to recognize an image set, a gallery of reference image sets is required for comparison, with the idea being to match a probe image set to one of the image sets in the gallery. If a match is found the probe image set is recognized. If a match is not found it is regarded that the gallery does not contain the identity of the probe image set and the identity is unknown. Typically each image in the gallery will have identifying information associated with it, so that in the event of a match the probe image set can also be associated with the identifying information of the matched gallery image set.

The gallery is stored in a storage means of the recognition device 10, such as memory 24 (for example RAM), mass storage 18 (for example a flash drive or hard disk drive) or on a networked storage device. The gallery will comprise a plurality of image sets, where again each image set has a 2-D image registered with a 3-D image. An example structure of the gallery 310 is shown in FIG. 9.

When the gallery of image sets is first formed and when an image set is added to the gallery, it is preferred to pre-process each image set with the same pre-processing as the probe image, as described below, prior to comparison with the probe image set. This means that there is not an undue delay in the recognition process. In addition, further processing of the gallery is “off-line” prior to “on-line” rejection comparison and matching comparison is also desirable. For example each 2-D image 312 has extracted from it 2-D holistic features 316 and 2-D local features 318. Each 3-D image 314 has extracted from it 3-D holistic features 320, 3-D local features 322 and segments 324. This allows the comparisons to be conducted in stages, such as stage 1 326, which is a rejection comparison of 2-D holistic features and 3-D holistic features; stage 2 328, which is a rejection comparison of 2-D local features and 3-D local features; and stage 3 330, which is a matching comparison of 3-D local features and/or 3-D segments. This is described in more detail below.

Referring to FIG. 2, the processor 22 is configured to operate as a rejection classifier 32 for rejecting images in the gallery that do not match the probe image set with a high likelihood, and a matching classifier 36 for identifying an image with a high likelihood of matching segmented non-rejected gallery images.

In an embodiment the processor 22 is further configured to operate as a pre-processor 30. The pre-processor 30 pre-processes the image set acquired from the camera 12. Pre-processing comprises normalization, such as spike removal, gap filing, localization to a part of the image of interest, and orientation (pose) correction.

In an embodiment the processor 22 is further configured to operate as an image segmentor 34 for segmenting images. Although the rejection classifier 32 may incorporate an image segmentor in some embodiments.

A particular application of the image recognition device 10 of the present invention is in face recognition. Face recognition will therefore be used as an example of an application of the present invention, although the invention is not intended to be limited this particular application only. Other examples include object recognition for robotic applications, such as gasping analysis, industrial applications such as automatic assembly of parts and automatic inspection of manufactured parts and landmark recognition for automatic navigation.

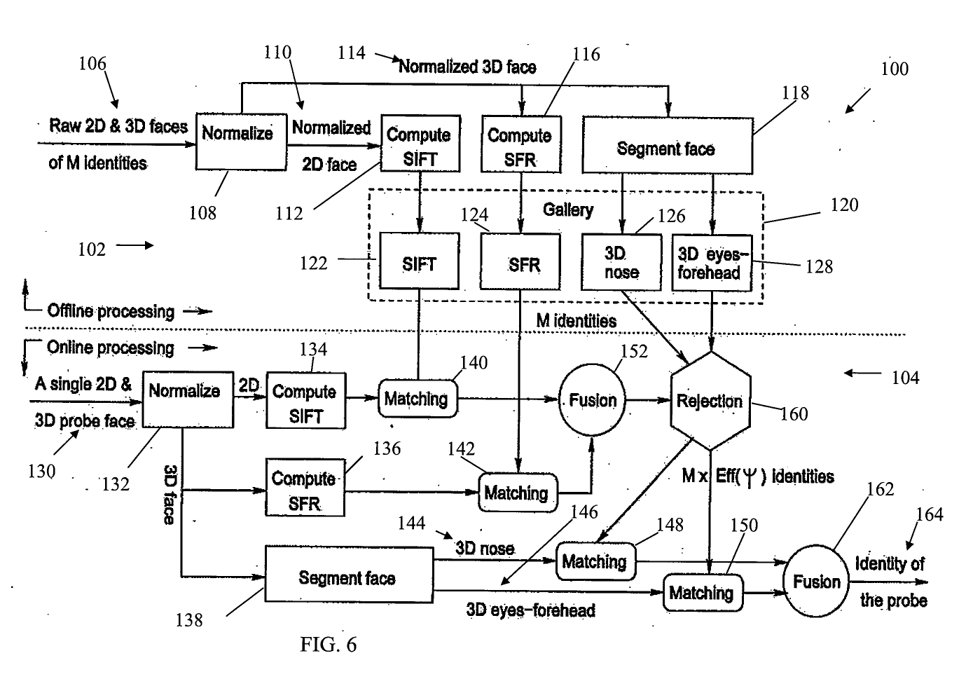

Referring to FIG. 6, a flowchart of an embodiment of a method of face recognition 100 is shown, which is performed by the image recognition device 10. The method 100 has an offline processing part 102 and an online processing part 104. The offline processing part 102 commences with receiving M image sets 106, where each image set comprises a raw 2-D image of a face and a registered raw 3-D image of the same face. Each of the image sets are pre-processed, including normalization 108. Preprocessing is described in more detail below. Each image set has computed image representations for storage in the gallery 120. In this embodiment the feature representations are of 2-D local features and 3-D holistic features. In particular each normalized 2-D face image 110 is then used to compute 112 a 2-D local feature representation for each 2-D face. In this case the 2-D local feature representation is a SIFT, which are 10 described further below. The feature representation (SIFT) is stored 122 as part of the gallery 120. Other 2-D local feature representations could also be used.

Scale Invariant Transforms (SIFTs) are 2-D local features calculated at keypoint locations and are described in D. Lowe, “Distinctive Image Features from Scale-Invariant Key Points”, Int'l J. Computer Vision, vol. 60, No. 2, pp 91-110, 2004. SIFTs are summarized below.

A cascaded filtering approach (keeping the most expensive operation to the last) is used to efficiently locate the keypoints, which are stable over scale space. First, stable keypoint locations in scale space are detected as the scale space extrema in the Difference-of-Gaussian function convolved with the 2-D image. A threshold is then applied to eliminate keypoints with low contrast followed by the elimination of keypoints, which are poorly localized along an edge. Finally, a threshold on the ratio of principal curvatures is used to select the final set of stable keypoints. For each keypoint, the gradient orientations in its local neighbourhood are weighted by their corresponding gradient magnitudes and by a Gaussian-weighted circular window and put in a histogram. Dominant gradient directions, that is, peaks in the histogram, are used to assign one or more orientations to the keypoint.

At every orientation of a keypoint, a feature is extracted from the gradients in its local neighbourhood. The coordinates of the feature and the gradient orientations are rotated relative to the keypoint orientation to achieve orientation invariance. The gradient magnitudes are weighted by a Gaussian function giving more weight to closer points. Next, 4×4 sample regions are used to create orientation histograms, each with eight orientation bins forming a 4×4×8=128 element feature vector. To achieve robustness to illumination changes, the feature vector is normalized to unit length, large gradient magnitudes are then thresholded, for example, so that they do not exceed 0.2 each, and the vector is renormalized to unit length. Some features can successfully be used for object recognition under occlusions.

Also, each normalized 3-D face 114 is used to compute 116 a 3-D holistic feature representation for each 3-D face, which are stored 124 as part of the gallery 120. In this case the 3-D holistic feature representation is a SFR, which is described further below.

The normalized 3-D face 114 also undergoes segmentation 118, where segments are stored 126 and 128 as part of the gallery 120. In this example segmentation 118 is performed on uniform face areas of the nose, and the eye and forehead region of the face. Stored 2-D local feature representations 122, 3-D holistic feature representations 124 and segmented portions of the 3-D face form the gallery 120 and are used in comparison with a probe image set 130 of a face in the online processing 104.

In the online processing part 104 a probe image set 130 is received. The probe image set 130 comprises a single 2-D image of a face and a 3-D image of the face for comparison with the faces in the gallery 120 in order to identify the face in the probe image set 130. In an embodiment multiple faces can be recognized sequentially, although the process could be operated in parallel to recognize multiple faces simultaneously. The probe image set 130 is normalized at 132. The normalized 2-D image is then used to compute 134 a 2-D local feature representation. The computation of 134 is the same as the computation of 112. Thus, in this example, the 2-D local feature representation is a SIFT.

The normalized 3-D image is then used to compute 136 a 3-D holistic feature representation. The computation 136 is the same as computation 116 of the offline process 102. Thus, in this example, the 3-D holistic feature representation is a SFR.

The normalized 3-D face is then also segmented 138 to produce a 3-D nose segment 144 and a 3-D eyes and forehead segment 146.

The probe face's 2-D local feature representation is compared 140 to each 2-D local feature representation 122 of the gallery 120. The comparison produces a similarity score for each identity in the gallery 120.

The 3-D holistic feature representation (SFR) of the probe is compared 142 by the rejection classifier 32 to the 3-D holistic feature representation of each identity's face in the gallery 120. The comparison involves determining a similarity score. The similarity scores of the 2-D holistic feature matching 140 and the corresponding similarity scores of the 3-D holistic feature matching 142 are fused at 152. Those faces which have sufficient similarity, as determined by the fused similarity scores, are retained and those that do not have sufficient similarity, as determined by the fused similarity scores, are rejected at 160.

The remaining (non-rejected) faces in the gallery 120 then have their segmented features compared by the matching classifier 36 at 148 and 150 (that is the 3-D nose of the probe is matched with each 3-D nose of each face in the gallery, and the 3-D eyes and forehead region of the probe are matched against each of the 3-D eyes and forehead region of each image in the gallery 150). Each of these comparisons 148 and 150 produces a similarity score. The similarity scores for each identity's face are fused at 162. The identity with the face which has the highest similarity according to the similarity score is taken to be the identity 164 of the probe.

It is noted that alternative 2-D local feature representation and 3-D holistic feature representation rejection classification (steps 112, 116, 134, 137, 140, 142, 152 and 160) can be used. Alternatives to the segmentation process (118 and 138) and matching process (148,150 and 162) can also be used.

In particular the 2-D local feature representation, 3-D holistic representation and segmentation may differ from SIFT, SFR and uniform segmentation, respectively. Furthermore 2-D holistic feature based comparisons may be used as well as or instead of the 2-D local feature comparison, and local featured based comparisons may be used as well or instead of 3-D holistic comparison and segmentation.

Examples of 2-D holistic features include Eigenfaces, Fisherfaces and Independent Component Analysis (ICA).

Fisherfaces are described in P. Belhumeur, J. Hespanha, and D. Kriegman, “Eigenfaces vs Fisherfaces: Recognition Using Class Specific Linear Projection,” IEEE Trans. Pattern Analysis and Machine Intelligence, vol. 19, pp. 711-720, 1997.

Eigenfaces are described in M. Turk and A. Pentland, “Eigenfaces for Recognition,” J. Cognitive Neuroscience, vol. 3, 1991.

Independent Component Analysis is described in M. S. Bartlett, H. M. Lades, and T. Sejnowski, “Independent Component Representation for Face Recognition,” Proc. SPIE Symp. Electronic Imaging, pp. 528-539, 1998.

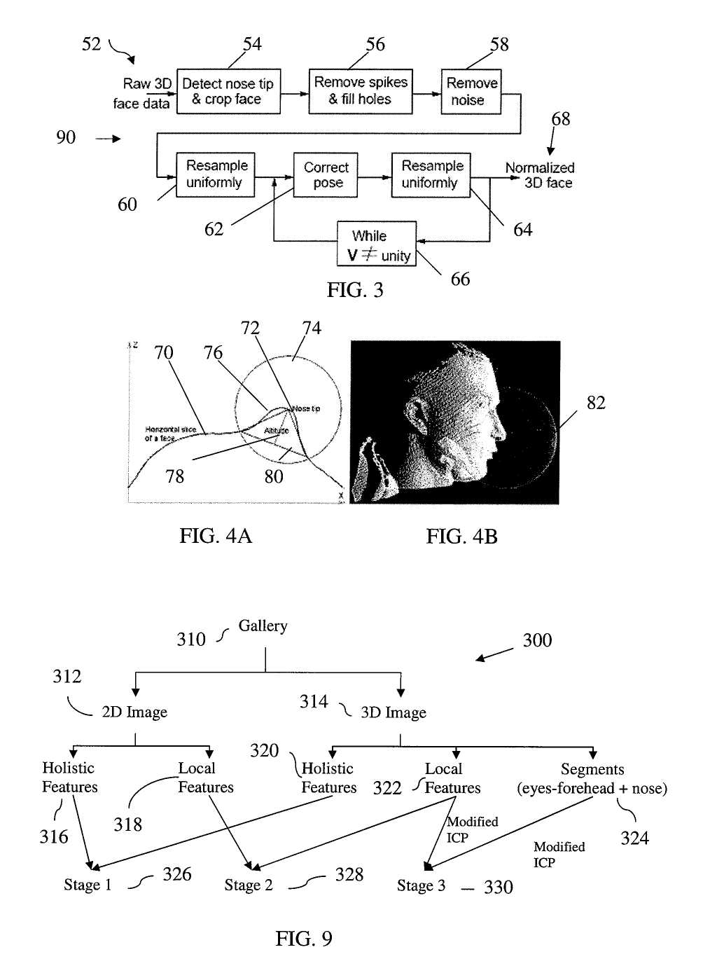

Referring to FIG. 3, a method 90 of pre-processing performed by the pre-processor 30 is shown. Most cameras acquire faces from the shoulder level up. A pre-processing step can be used to localize the face. A combination of appearance based face detection and 3-D based face detection is used. Using raw 3-D image data 52 the nose tip is detected 54 in order to crop out an unwanted part of the image from the required facial area for further processing.

The nose tip is detected using a coarse to fine approach as follows. The 3-D image of the probe is horizontally sliced at multiple steps dv. An example horizontal slice 70 is shown in FIG. 4A. Initially a large value is selected for dv to improve speed. Once the nose is coarsely located the search is repeated in the neighbouring region with a smaller value of dv. The data points of each slice are interpolated at uniform intervals to fill in any holes. Interpolation is the process of finding missing data points using the neighbouring data. For example if the depth of the two points is 3 and 5 and there is one missing point in between them then the depth of the missing point will be 4 using linear interpolation. Other types of interpolation can also be used which use more than just the two neighbouring points e.g. fit a square curve or a cubic curve (cubic interpolation) the to data points and then find the missing points.

Next, circles 74 centred at multiple horizontal intervals dh on the slice 70 are used to select a segment 80 from the slice, and a triangle is defined using the centre of the circle 74 and the points of intersection with the slice with the circle 74 as the corners of the triangle. The segment 80 is defined as a line extending between the points of intersection of the slice 70 and the circle 74. Once again a coarse to fine approach is used for selecting the value of dh. An altitude of the triangle is defined as a line perpendicular to segment 80 which intersects the centre of the circle 74. The point which has the maximum altitude 78 triangle associated with it is considered to be a potential nose tip 72 on the slice and is assigned a confidence value equal to the length of the altitude 78. This process is repeated for all slices resulting in one candidate point per slice along with its confidence value. These candidate points correspond to the nose ridge and should form a line in the x-y plane.

Some of these points may not correspond to the nose ridge. These are outliers and are removed by robustly fitting a line to the candidate points using Random Sample Consensus, which is described in P. Kovesi, “MATLAB and Octave Functions for Computer Vision and Image Processing”, http://people.csse.uwa.edu.au/pk/Research/MatlabFns/index.html, 2006. Out of the remaining points, the one which has the maximum confidence is taken as the nose tip 72. The above process is repeated at smaller values of dv and dh in the neighbouring region of the nose tip 72 for a more accurate localization.

As shown in FIG. 4B, a sphere 82 of radius r centred at the nose tip 72 is then used to crop the 3-D image and its corresponding registered 2-D image. r is for example 80 mm.

The 3-D image is then processed 56 to remove outlier points (spikes) using distance thresholding and fill holes using interpolation. Outlier points are defined as the points having a distance greater than a threshold dt from any one of its 8-connected neighbours. dt is automatically calculated using dt=μ+0.6σ (where μ is the mean distance between neighbouring points and σ is its standard deviation). Removal of spikes may result in holes in the 3-D image which are filled using cubic interpolation. Since noise in 3-D data generally occurs along the viewing direction (z-axis) of the sensor, the z-component of the 3-D image is denoised 58 using median filtering Median filtering replaces each pixel (depth value) in the range image by the median of its eight neighbourhood.

After this the 3-D image and its corresponding 2-D image are resampled 60 on a uniform square grid at 1 mm resolution. Resampling the 2-D image on a similar grid as the 3-D image ensures that a one-to-one correspondence is maintained between the two.

Once the images are cropped and denoised, their orientation (pose in the case of a face) is corrected 62 using the Hotelling transform, which is also known as the Principle Component Analysis (PCA), as follows.

Let P be a 3×n matrix of the x, y and z coordinates of the point-cloud of a face (Eqn. 1).

$$P = [ \begin{matrix}{x}_{1} & {x}_{2} & … & {x}_{n} \\ {y}_{1} & {y}_{2} & … & {y}_{n} \\ {z}_{1} & {z}_{2} & … & {z}_{n} \text{\textbar}\end{matrix} ] \qquad ( 1 )$$

The mean vector m and the covariance matrix C of P are given by

$$\begin{matrix}m = \frac{1}{n} {\sum }_{k = 1}^{n} {P}_{k} , \\ and & ( 2 ) \\ c = \frac{1}{n} \sum {P}_{k} {P}_{k}^{T} - m {m}^{T} , & ( 3 )\end{matrix}$$

where Pₖ is the k^{th} column of P. Performing PCA on the covariance matrix C gives a matrix V of eigenvectors and a diagonal matrix D of eigenvalues such that

CV=DV (4)

V is also a rotation matrix that aligns the point-cloud P on its principal axes, that is

P′=V(P−m). (5)

Pose correction 62 may expose some regions of the face (especially around the nose) which are not visible to the 3-D scanner. These regions have holes which are filled using interpolation. The face is resampled 64 once again on a uniform square grid (at for example 1 mm) resolution and the above process of pose correction and resampling is repeated 66 until V converges to an identity matrix. Faces with small aspect ratio are prone to misalignment errors along the z-axis. Therefore, after pose correction along the x and y axes, a smaller region may be cropped from the face using a radius of for example 50 mm (centred at the nose tip 72) and a depth threshold equal to the mean depth of the face (with r=80 mm). This results in a region with a considerably higher aspect ratio which is used to correct the facial pose along the z-axis.

Resampling the face on a uniform square grid has another advantage, faces end up with the same resolution. This can be important for the accuracy of the 3-D matching comparison, which in this embodiment is based on measuring point to point distances. Differences in the resolution of the faces can bias the similarity scores in favour of faces that are more densely sampled. This makes sense because for a given point in a probe face, there are more chances of finding a closer point in a densely sampled gallery face compared to a rarely sampled one.

V is also used to correct the orientation of the registered 2-D image. The R, G and B pixels are mapped onto the point-cloud of the 3-D face and rotated using V. This may also result in missing pixels which are interpolated using cubic interpolation. To maintain a one-to-one correspondence with the 3-D image as well as for scale normalization, the 2-D coloured image of the face is also resampled in exactly the same manner as the 3-D image.

The resulting normalized 3-D image 68 (and 2-D image) are then sent to the rejection classifier 32. The rejection classifier 32 is a classifier that quickly eliminates a large percentage of the candidate classes with high probability. The rejection classifier 32 uses a process that given an input set of classes, returns a small subset that contains the target class. The smaller the output subset—the more effective the rejection classifier 32. The effectiveness of the rejection classifier 32 is the expected cardinality of the rejecter output, that is the output subset of classes, divided by the total number of classes. The rejection classifier 32 may operate in a cascading fashion, such that it comprises a plurality of rejection techniques, where faster techniques are used first and the results are passed on to the next stage. Each stage is more accurate than the previous one.

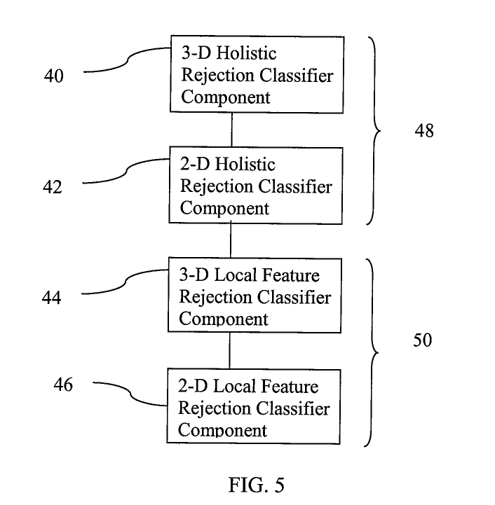

Referring to FIG. 5, in an embodiment the rejection classifier 32 is comprised of one or more of a first stage 48 which has one or both of a 3-D holistic feature rejection classifier component 40 and a 2-D holistic feature rejection classifier component 42, and a second stage 50 which has one or both of a 3-D local feature rejection classifier component 44 and a 2-D local feature rejection classifier component 46.

In the first stage 46, 2-D and 3-D holistic features are extracted from the probe image set and matched with similar extracted features of the gallery image sets. The first stage 46 of the rejection classifier 32 rejects unlikely images and only a subset of the gallery is left for further processing. This speeds up the recognition process.

The 3-D holistic feature rejection classifier component 40 uses a Spherical Face Representation (SFR). Intuitively, an SFR can be imagined as the quantization of the point-cloud of an image into spherical bins centred at a point, such as the nose tip 72. To compute an n bin SFR, the distance of all points from the centre point is calculated. These distances are then quantized into a histogram of n+1 bins. The outermost bins are is then discarded since they are prone to errors (e.g. due to hair). An SFR is a soft descriptor of the face and is not particularly sensitive to facial expressions. SFRs belonging to the same individual follow a similar curve shape which is likely to be different from that of a different identity. The similarity between a probe and gallery image set is computed by measuring the distance between their SFR vectors. To speed up the matching indexing and/or hash tables are used.

In the 2-D domain, holistic appearance based features can be used in the 2-D rejection classifier component 42. In one embodiment the 2-D holistic features used in the 2-D holistic rejection classifier component 42 are Eigenfaces, Fisherfaces and Independent Component Analysis (ICA).

The results of the 2-D rejection classifier component 42 can be combined with the results of the 3-D rejection classifier component 40 in the first stage 46 of the rejection classifier 32. Specifically matching scores of 2-D and 3-D features are fused using a weighted sum rule and a threshold is used to reject unlikely image sets from the gallery. The threshold can be selected according to the application. The invention is not limited to the 2-D and 3-D feature types given as examples and can be replaced with others.

The second stage 50 involves a selective 3-D local feature comparison performed by the 3-D local feature rejection classifier component 44 and a selective 2-D local feature comparison performed by the 2-D local feature rejection classifier component 46. The 3-D local feature comparison is performed as follows.

First, the 3-D image is processed to automatically detect keypoints. The aim of keypoint detection is to determine points on a surface (in this example a 3-D face) which can be identified with high repeatability in different range images of the same surface in the presence of noise and orientation (pose) variations. In addition to repeatability, the features extracted from these keypoints should be sufficiently distinctive in order to facilitate accurate matching. The keypoint identification technique is simple yet robust due to its repeatability and the descriptiveness of the features extracted at these keypoints.

The classifier component 44 receives a point-cloud of an input 3-D image, such as a face, which is sampled at uniform (x, y) intervals and at each sample point p, a local surface is cropped from the face using a sphere of radius r₁ centred at p. Different values of r₁ are used to crop local regions of different sizes.

The local region is orientation (pose) corrected using the technique 62 described above. However, only a single iteration is used this time. If the difference between the length of the major (x) and minor (y) axes of the local region is greater than a threshold, the point p is selected as a keypoint. The threshold can be adjusted according to the number of required keypoints. The smaller the threshold the greater are the number of detected keypoints. This keypoint detection technique can be used for 3-D objects other than faces.

Once a keypoint has been detected, a local feature is extracted from its neighbourhood L′. The principal directions of the local surface L′ are used as the 3-D coordinates to calculate the feature. This makes the feature orientation (pose) invariant. Since the keypoints are detected such that there is no ambiguity in the principal directions of the neighbouring surface, the derived 3-D coordinate bases are stable and so are the features. A surface is fitted to the points in L′ using approximation as opposed to interpolation. In approximation, the surface need not necessarily pass through the data points. This way the surface fitting is not sensitive to noise and outliers in the data. Each point in L′ pulls the surface towards itself and a stiffness factor controls the flexibility of the surface. The surface is first sampled on a uniform lattice and then cropped to a smaller central surface so as to avoid boundary effects. For example if the central surface is a 20×20 lattice, a feature vector of dimension 400 is formed.

An upper limit is imposed on the total number of local features that are calculated for an image in the gallery. This is important in order to avoid the recognition results being biased in favour of the gallery images that have more local features. For example, for every face in the gallery, a total of 200 feature vectors are calculated. The 200 keypoints are selected using a uniform random distribution. The feature vectors are then compressed by projecting them into a subspace defined by the eigenvectors of their largest eigenvalues using Principal Component Analysis (PCA).

Let F=[f₁ . . . f_{200N}] (where N is the gallery size and 200 is the number of feature vectors) be the v_{dim}×200N matrix of all the feature vectors of all the faces in the gallery. v_{dim} is the dimension of the feature vector. Each column of F contains a feature vector of dimension v_{dim}. The mean of F is given by

$$\overline{f} = \frac{1}{200 N} {\sum }_{i}^{200 N} {f}_{i} . \qquad ( 6 )$$

The mean feature vector is subtracted from all features

f′ᵢ=fᵢ− f̅. (7)

The mean subtracted feature matrix becomes

F′[f′¹ . . . f′_{200N}]. (8)

The covariance matrix of the mean subtracted feature vectors is given by

C=F′(F′)^{T}, (9)

where C is a 400×400 covariance matrix. The eigenvectors and eigenvalues of C are calculated using Singular Value Decomposition:

USV^{T}=C,

where U is a 400×400 matrix of eigenvectors sorted in decreasing order. S is a diagonal matrix of the corresponding eigenvalues. The dimension of PCA subspace is decided according to the required fidelity in the projected subspace. Experiments have shown that the first 11 eigenvectors give more than 99% fidelity and results in a compression ratio of 13/400. The projected feature are calculated as follows

F^{λ}=(Uₖ)^{T}F′ (11)

where Uₖ contains the first k eigenvectors of U. The projected vectors are then normalized by dividing them by their eigenvalues so that the variance along each dimension is equal. The normalized projected 3-D features are then indexed using a hash table. To do this, each of the k dimensions is divided into appropriate bins. Next, for each feature vector an entry is made in the hash table at the appropriate bin location. The entry will contain the index values of the feature as well as the gallery image set.

During comparison by component 44, the probe is processed in exactly the same way to find keypoints and extract local features from these keypoints. The features are projected to the PCA subspace using the same Uₖ matrix and mean vector and then normalized.

fₚ^{λ}=(Uₖ)^{T}(fₚ− f̅) (12)

The resultant vector is then used in combination with the hash table to cast votes to features/gallery images. The gallery images which receive the maximum number of votes are considered for further matching. The features of these gallery images and those of the probe are matched using the following approach.

The local features are compared using the following equation

e=cos ⁻¹(fₚ^{λ}(f_{g}^{λ})^{T}) (13)

where p and g stand for probe and gallery respectively. ‘e’ represents the error between the two vectors.

This local feature comparison can be used to compare 2-D or 3-D or multimodal 2-D-3-D (combined 2-D and 3-D) features of different types using the same matching technique.

If the two features are exactly equal, the value of e will be zero indicating a perfect match. However, in reality a finite error will exist between the features extracted from the exact same locations on different images of the same subject. For a given probe feature, the feature from the gallery image that has the minimum error with it is taken as its match. Once all the features are matched, the list of matching features is sorted according to e. If a gallery feature matches more than one probe feature, only the one with the minimum value of e is considered and the rest are removed from the list of matches. This allows for only one-to-one matches and the total number of matches m is different for every matching of probe-gallery images. The total number of matches m is the first indicator of the similarity between the two images and the second indicator is the mean error between the matching pairs of features. However, the two indicators or similarity measures have opposite polarity, that is, the more the number of matches the more the similarity (positive polarity), whereas the smaller the value of average error, the greater the similarity (negative polarity).

The keypoints corresponding to the matching features on the probe image are projected on the x-y plane, meshed using Delaunay triangulation (see http://mathworld.wolfram.com/DelaunayTriangulation.html) and projected back to the 3-D space. This results in a 3-D graph. The edges of this graph are used to construct a graph from the corresponding nodes (keypoints) of the gallery face using the list of matches. If the list of matches is correct, that is, the matching pairs of features correspond to the same location on the probe and gallery face, and hence will result in a similar graph, then the similarity γ (gamma) between the two graphs is calculated by calculating the average difference between the edge lengths of the corresponding edges of the two graphs using the following equation.

$$γ = \frac{1}{{n}_{ɛ}} {\sum }_{i}^{{n}_{ɛ}} \vert {ɛ}_{pi} - {ɛ}_{gi} \vert \qquad ( 14 )$$

where εₚᵢ and ε_{gi} are the lengths of the corresponding edges of the probe and gallery graphs, respectively. The value n_{ε} is the number of edges. Eqn, 14 is an efficient way of measuring the spatial error between the two graphs. Gamma is the third similarity measure between the two faces and has negative polarity.

A fourth similarity measure (with negative polarity) between the two faces is calculated as the mean Euclidean distance d between the nodes of the two graphs after least squared error minimization. Outlier nodes which have an error above a threshold are removed before calculating the mean error. The threshold is determined from the resolution of the image and the sampling.

The four similarity measures are normalized on the scale of 0 to 1, converted to similar polarity and fused using a confidence weighted summation rule to calculate the final 3-D local feature based similarity between the two images. The confidence is calculated from the distance of the 2^{nd} best similar image and 3^{rd} best similar image from the best similar image. In addition to this fusion rule other rules can also be employed including borda count, consensus voting and product rule. See for example http://en.wikipedia.org/wiki/Borda_count.

The 2-D feature comparison performed by the 2-D local feature rejection classifier component 46 is as follows. For each cropped local 3-D region at a keypoint determined by component 42, the 2-D image is also cropped accordingly. The surface of the local 3-D region is also used to normalize the orientation (pose) of the corresponding 2-D region. A local feature is then extracted from the 2-D region and then projected to the PCA space (for compression). The 2-D features for the probe are matched with those of the gallery images using the same approach described above for 3-D feature comparison.

The similarity measures due to 2-D and 3-D local features are also fused using a confidence weighted summation rule and multimodal local features based similarity measure determined using Eqn (13) is used to reject more faces leaving only a few non-rejected gallery images.

It may happen that after stage 50 all gallery faces are rejected except one. In such a case matching classifier 36 has a trivial task if it is assumed the identity is in the gallery. In that case the identity of the probe face is announced (output) as that of the left over face. If however this assumption is not used, then the matching classifier 36 continues as described below.

Finding the keypoint and its neighbourhood serves as segmentation, and may be used instead of or in addition to the segmentation described below.

In one embodiment the matching classifier 36 operates to perform a classification stage as follows. Each local region, cropped after stage 50, of the probe image set is registered to its matching region of the gallery image sets. It is noted that the matching pairs of local regions have already been calculated in the previous stage. For even better accuracy, the top N matching local regions (or close competitors) can be further processed using this technique and the best match selected. The registration removes any normalization errors and gives a least squares fitting error between the two local regions (3-D surfaces) which is a more accurate estimate of the similarity between the two local regions compared to the error e calculated in stage 50. The error is calculated in the normal direction to the surfaces. The error scores of multiple pairs (one from the probe image set and one from a gallery image set) of matching regions are fused using different rules including sum, product, borda count and consensus voting to find the similarity between the two faces.

In an embodiment the image with the most similarity as determined by the similarity score from this classification stage is regarded as the recognized identity.

In an other embodiment the similarity scores from the stage 48, stage 50 and the classification stage are fused using different rules including confidence weighted sum, product, borda count and consensus voting to get a final decision on the recognition of the face.

As an alternative or in addition to the local feature rejection classification of stage 50, the probe image set is segmented by the image segmentor 32. The image segmentor 32 segments the 3-D face into expression sensitive regions and expression insensitive regions. Two different approaches can be used to this purpose. The first is a uniform segmentation, which segments the same features in all faces. The second approach performs a non-uniform based approach, which is based on the properties of individual faces.

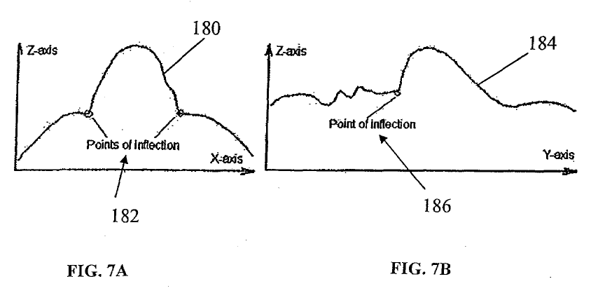

In an embodiment uniform segmentation eliminates areas of the face that are more sensitive to facial expression. Experimentation has shown the region around the nose, eyes and forehead are the least sensitive to facial expressions. The features automatically segmented by detecting the inflection points 182 around the nose tip 72 for horizontal slices 180 of FIGS. 7A and 7B. These inflection points are used to define a mask which segments the nose, eyes and forehead region from a face.

In an embodiment non-uniform face segmentation is as follows. A number of example images with non-neutral expressions are divided into training and test sets. The training set is used during offline processing to automatically determine the regions of the face which are the least affected by expressions. In an embodiment three training faces per gallery face are used. The variance of all training faces (with non-neutral expression) from their corresponding gallery faces (with neutral expression) is measured. Regions of the gallery faces whose variance is less than a threshold are then segmented for use in the recognition process. The threshold is dynamically selected in each case as the median variance of the face pixels. It is noticeable that generally the forehead, the region around the eyes and the nose are the least affected by expressions (in 3-D) whereas the cheeks and the mouth are the most affected.

In an embodiment the matching classifier 36 uses a variant of the iterative closest point algorithm (ICP) (See P. J. Besl and N. D. McKay, “Reconstruction of Real-World Objects via Simultaneous Registration and Robust Combination of Multiple Range Images”, IEEE Trans. Pattern Analysis and Machine Intelligence, vol. 14, No. 2 pp 239-256, February 1992.) ICP establishes correspondences between the closest points of two sets of 3-D point-clouds and minimizes the distance error between them by applying a rigid transformation to one of the sets. This process is repeated iteratively until the distance error reaches a minimum saturation value. It also requires a prior coarse registration of the two point-clouds in order to avoid local minima using the automatic pose correction 62 (described above). The modified version of the ICP algorithm follows the same routine except that the correspondences are established along the z-axis only. The two point-clouds are mapped onto the x-y plane before correspondences are established between them. This way, points that are close in the x-y plane, but far in the z-axis are still considered corresponding points. The distance error between such points provides useful information about the dissimilarity between two faces. However, points whose 2-D distance in the x-y plane is more than the resolution of the faces (for example 1 mm) are not considered as corresponding points. Once the correspondences are established, the point-clouds are mapped back to their 3-D coordinates, and the 3-D distance error between them is minimized. This process is repeated until the error reaches a minimum saturation value.

Let P=[xₖ, yₖ, zₖ]^{T} (where k=1 . . . nₚ) and G=[xₖ, yₖ, zₖ]^{T} (where k=1 . . . n_{G}) be the point-cloud of a probe and a gallery face, respectively. The projections of P and G on the x-y plane are given by \hat{P}=[xₖ, yₖ] and Ĝ=[xₖ, yₖ]^{T}, respectively. Let F be a function that finds the nearest point in \hat{P} to every point in Ĝ:

(c,d)=F(\hat{P},Ĝ) (16)

where c and d are vectors of size n_{G} each such that cₖ and dₖ contain, respectively, the index number and distance of the nearest point of \hat{P} to the k^{th} point of Ĝ. For all k, find gₖ ε G and p_{ck} ε P such that dₖ<dᵣ (where dᵣ is the resolution of the 3-D faces, equal to 1 mm in this example). The resulting gᵢ, correspond to pᵢ, for all i=1 . . . N (where N is the number of correspondences between P and G). The distance error e to be minimized is

$$e = \frac{1}{N} {\sum }_{i = 1}^{N} ‖ {Rg}_{i} + t - {p}_{i} ‖ \qquad ( 17 )$$

Note that e is the 3-D distance error between the probe and the gallery as opposed to 2-D distance. This error e is iteratively minimized and its final value is used as the similarity score between the probe and gallery face. To avoid local minima, a coarse to fine approach is used by initially setting a greater threshold for establishing correspondences and later bringing the threshold down to dᵣ. A higher initial threshold allows correspondences to be established between distant points in case the pose correction performed during normalization was not accurate.

The rotation matrix R and the translation vector t can be calculated using a number of approaches including Quaternions and the classic SVD (Singular Value Decomposition) method (K. Arun, T. Huang, and S. Blostein, “Least-Squares Fitting of Two 3-D Point Sets”, IEEE Trans. Pattern Analysis and Machine Intelligence, vol. 9, No. 5, pp 698-7090, 1897.). An advantage of the SVD method is that it can easily be generalized to any number of dimensions. The mean of pᵢ, and gᵢ is given by

$$\begin{matrix}{μ}_{p} = \frac{1}{N} {\sum }_{i = 1}^{N} {p}_{i} \\ and & ( 18 ) \\ {μ}_{g} = \frac{1}{N} {\sum }_{i = 1}^{N} {g}_{i} , respectively . & ( 19 )\end{matrix}$$

The cross correlation matrix K between pᵢ, and gᵢ, is given by

$$K = \frac{1}{N} {\sum }_{i = 1}^{N} ( {g}_{i} - {u}_{g} ) {( {p}_{i} - {u}_{p} )}^{T} \qquad ( 20 )$$

### Performing a Singular Value Decomposition of K

UAV^{T}=K (21)

gives us two orthogonal matrices U and V and a diagonal matrix A. The rotation matrix R can be calculated from the orthogonal matrices as

R=VU^{T}, (22)

whereas the translation vector t can be calculated as

t=μₚ−Rμ_{g}. (23)

R is a polar projection of K. If det (R)=−1, this implies a reflection of the face in which case R is calculated using

$$R = V [ \begin{matrix}1 & 0 & 0 \\ 0 & 1 & 0 \\ 0 & 0 & det ( {UV}^{T} )\end{matrix} ] {U}^{T} \qquad ( 24 )$$

Each matching engine (3-D holistic rejection classifier component 40, 2-D holistic rejection classifier component 42, 3-D local feature rejection classifier component 44 and 2-D local feature rejection classifier component 46 and segment matching algorithm) results in a similarity matrix Sᵢ (where i denotes a modality) of size P×M (where P is the number of tested probes, and M is the number of faces in the gallery). An element s_{rc} (at row r and column c) of a matrix Sᵢ denotes the similarity score between probe number r and gallery face number c. Each row of an Sᵢ represents an individual recognition test of probe number r. All the similarity matrices have a negative polarity in this case, that is, a smaller value of s_{rc}, means high similarity. The individual similarity matrices are normalized before fusion. Since none of the similarity matrices had outliers, a simple min-max rule (Eqn. 25) was used for normalizing each row (recognition test) of a similarity matrix on a scale of 0 to 1

$$\begin{matrix}{S}_{ir}^{′} = \frac{{S}_{ir} - min ( {S}_{ir} )}{max ( {S}_{ir} - min ( {S}_{ir} ) ) - min ( {S}_{ir} - min ( {S}_{ir} ) )} & ( 25 ) \\ S = {\prod }_{i = 1}^{n} {S}_{i}^{′} , & ( 26 )\end{matrix}$$

where i=1 . . . n (the number of modalities) and r=1 . . . P (the number of probes). Moreover, max(Sᵢᵣ) and min(Sᵢᵣ), respectively, represent the minimum and maximum value (that is, a scalar) of the entries of matrix Sᵢ in row r. The normalized similarity matrices S′ᵢ are then fused to get a combined similarity matrix S. Two fusion techniques were tested, namely, multiplication and weighted sum. The multiplication rule (Eqn 26) resulted in a slightly better verification rate but a significantly lower rank-one recognition rate. Therefore, the weighted sum rule (Eqn 27) is preferred to be used for fusion as it produces overall good verification and rank-one recognition results

$$\begin{matrix}{S}_{r} = {\sum }_{i = 1}^{n} {κ}_{i} {κ}_{ir} {S}_{ir}^{′} & ( 27 ) \\ {κ}_{ir} = \frac{mean ( {S}_{ir}^{′} ) - min ( {S}_{ir}^{′} )}{mean ( {S}_{ir}^{′} ) - {min}_{2} ( {S}_{ir}^{′} )} & ( 28 )\end{matrix}$$

In Eqn 27, κᵢ is the confidence in modality i, and κᵢᵣ is the confidence in recognition test r for modality i. In Eqn 28, min₂(S′ᵢᵣ) is the second minimum value of S′ᵢᵣ. The final similarity matrix S is once again normalized using the min-max rule (Eqn 29) resulting in S′, which is used to calculate the combined performance of the used modalities

$${S}_{r}^{′} = \frac{{S}_{r} - min ( {S}_{r} )}{max ( {S}_{r} - min ( {S}_{r} ) ) - min ( {S}_{r} - min ( {S}_{r} ) )} \qquad ( 29 )$$

When a rejection classifier is used, the resulting similarity matrices are sparse since a probe is matched with only a limited number of gallery faces. In this case, the gallery faces that are not tested are given a value of 1 in the normalized similarity matrix. Moreover, the confidence weight κᵢᵣ, is also set to 1 for every recognition trial. In some recognition trials, all faces are rejected but one. Since there is only one face left, it is declared as identified with a similarity of zero.

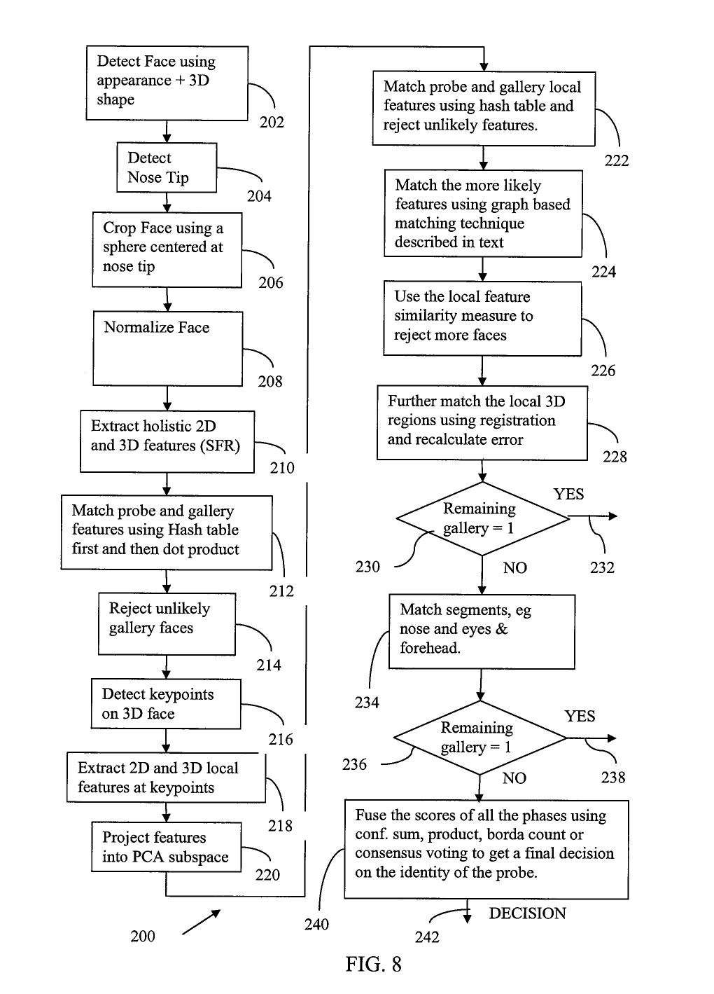

Referring to FIG. 8, a method 200 of face recognition is shown according to an embodiment of the present invention, which uses the device 10 described above. At 202 the pre-processor 30 detects a face in the probe image set using the appearance and 3-D shape. The pre-processor 30 detects 204 the nose tip 72 and crops 206 the face using a sphere centred at the nose tip 72 as described in 52 above. In step 208 the face is normalized by the pre-processor using steps 56, 58, 60, 62, 64 and 66.

The normalized face image set 68 then is provided to the first stage 48 of the rejection classifier 32. In the first stage 48, the 3-D Holistic Rejection Classifier Component 40 extracts 3-D holistic features (such as a SFR) and the 2-D Holistic Rejection Classifier Component 42 extracts 2-D holistic features in step 210. The 2-D and 3-D holistic features of the probe image set are fused and this is compared to a hash table of 2-D and 3-D holistic features of each gallery image set in step 212 using Eqn (13). The smaller the value of e, the better the match. Those gallery images with insufficient similarity are rejected 214 to complete the first stage 48.

Then in the second stage 50 of the rejection classifier 32, the 3-D Local Rejection Classifier Component 44 detects 216 keypoints on the 3-D face image. At 218 3-D local features are extracted at the keypoints by 3-D Local Rejection Classifier Component 44 and 2-D local features are extracted at the keypoints by 2-D Local Feature Rejection Classifier Component 46.

The 3-D Local Rejection Classifier Component 44 and the 2-D Local Feature Rejection Classifier Component 46 each perform the following with the 3-D local features and 2-D local features, respectively. At 220 the local features are projected into PCA space. At 222 the probe projected features are compared to gallery projected features using a hash table. Unlikely features are rejected. At 224 non-rejected features are compared using a graph based matching technique. At 226 local feature similarity measures are used to reject more gallery image sets.

At 228 local regions are compared using registration and an error is recalculated to reject further gallery image sets. At 230 a check is performed to determine if the number of non-rejected gallery image sets is equal to 1. If this is the case 232, then the second stage is concluded and the non-rejected gallery image set is provided to the matching classifier 36 to announce the identity or to perform further classification.

If there is more than one non-rejected gallery image, then in step 234 the segments can be matched by the matching classifier 36, for example using the modified ICP method described above. Again at 236 a check is performed to determine if the number of non-rejected gallery image sets is equal to 1. If this is the case 238, then the third stage is concluded and the non-rejected gallery image set is provided to the matching classifier 36 to announce the identity or to perform further classification. If there is more than one non-rejected gallery image, then in step 240 the matching classifier 36 takes the similarity scores produced by the second stage 50, fuses them using confidence sum, product, borda count or consensus voting to find the most likely match. The most likely match is then announced 242 as the identity of the probe image set.

It is noted that after calculation of each similarity score threshold comparisons can be applied so thin out clearly dissimilar image sets. For example is one or more images have a high similarity and another group of one or more have a distinctly low similarity then the low similarity scoring image sets of the gallery can be rejected without need to calculate additional similarity measures. The application of the threshold in this way should only remove image sets with a very low likelihood of being a match. The threshold can be a fixed value or a variable value, depending on the number of images in the gallery, or depending on the accuracy required by the application. In some instances a cut-off number of image sets progressing to the next similarity measure calculation may be applied instead of or in addition to the application of a threshold.

Modifications and variations may be made to the present invention without departing from the inventive concept.

What is claimed is:

1. An image recognition method comprising:
receiving a first image set to be recognized, wherein the image set comprises a 3-D image comprising 3-D cloud-points of an observed surface and a registered 2-D image comprising textured pixels;
providing a gallery of image sets for comparison;
performing a rejection comparison for rejecting image sets in the gallery that do not match the first image set with a high likelihood; and
performing a matching comparison for identifying an image set of the non-rejected gallery image sets which matches the first image set with a high likelihood.

2. An image recognition system comprising:
an input for receiving a first image set to be recognized, wherein the image set comprises a 3-D image comprising 3-D cloud-points of an observed surface and a registered 2-D image comprising textured pixels;
a storage for storing a gallery of image sets for comparison;
a rejection classifier for performing a rejection comparison for rejecting image sets in the gallery that do not match the first image set with a high likelihood; and
a matching classifier for performing a matching comparison for identifying an image set of the non-rejected gallery image sets which matches the first image set with a high likelihood.

3. An image recognition system comprising:
an input for receiving a first image set to be recognized, wherein the image set comprises a 3-D image comprising 3-D cloud-points of an observed surface and a registered 2-D image comprising textured pixels;
a storage for storing a gallery of image sets for comparison;
a processor configures to: perform a rejection comparison for rejecting image sets in the gallery that do not match the first image set with a high likelihood, and perform a matching comparison for identifying an image set of the non-rejected gallery image sets which matches the first image set with a high likelihood.

4. A computer program embodied in a computer readable storage medium comprising instructions for controlling a processor to:
receive a first image set to be recognized, wherein the image set comprises a 3-D image comprising 3-D cloud-points of an observed surface and a registered 2-D image comprising textured pixels;
access a storage of a gallery of image sets for comparison;
perform a rejection comparison for rejecting image sets in the gallery that do not match the first image set with a high likelihood; and
perform a matching comparison for identifying an image set of the non-rejected gallery image sets which matches the first image set with a high likelihood.
